(19) United States
(12) Patent Application Publication
(10) Pub. No.: US 2006/0259519 A1
(43) Pub. Date: Nov. 16, 2006

(54) Iterative definition of flat file data structure by using document instance

(75) Inventors: Ruslan Yakushev, Sammamish, WA (US); Tatyana S. Yakushev, Sammamish, WA (US); David Kent Downing, Bellevue, WA (US); Alvaro De Matos Miranda Filho, Bellevue, WA (US); Wei-Lun Lo, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/128,458

(22) Filed: May 12, 2005

(51) Int. Cl. G06F 17/30

(52) U.S. Cl. 707/201

(57) ABSTRACT

Flat file formats are used widely in Enterprise Application Integration (EAI) and Business to Business (B2B) solutions. The formats describe the layout of the meaningful information within the data stream in such a way so that the parsing of that stream and extraction of the information can be automated. An example of a flat file format is a Comma Separated Values (CSV) format, where units of data are delimited between each other by using comma character. Another example is a positional format where the units of data occupy certain positions relative to each other within the data stream. The common task that is performed very often is conversion of the documents from various flat file formats into an XML representations and vise versa. The algorithm of iterative definition of the flat file structure from document instance described herein simplifies the process of defining the conversion rules for the flat file formats. These rules are used by components that perform conversion from flat file format to XML and back. The algorithm allows definition of those rules by working with the flat file document instance and iteratively creating an XML schema from that instance.

### FIELD OF THE INVENTION

The invention relates generally to flat file formats. More particularly, the invention relates to systems and methods for defining conversion rules used by components that perform conversion from flat file format to XML and back.

### BACKGROUND OF THE INVENTION

Flat file formats are used widely in Enterprise Application Integration (EAI) and Business to Business (B2B) solutions. The formats describe the layout of the meaningful information within the data stream in such a way so that the parsing of that stream and extraction of the information can be automated. An example of a flat file format is a Comma Separated Values (CSV) format, where units of data are delimited between each other by using a comma character. Another example is a positional format where the units of data occupy certain positions relative to each other within the data stream.

A common task that is performed very often is conversion of the documents from various flat file formats into an XML representation and vice versa. Though the flat file to XML conversion components in known EAI products (e.g., Microsoft BizTalk Server 2000/2002/2004, BEA WebLogic Integration) provide rich support for parsing/serializing very complex flat file data structures, they lack the easy to use and intuitive user interface for defining the conversion rules. This results in low developer productivity when working with flat file formats as the developer spends most of her time learning about parsing rules, trying to develop the parsing schema and then debugging it. It would be desirable, therefore, if systems and methods were available to simplify the process of defining the conversion rules used by components that perform conversion from flat file format to XML and back.

### SUMMARY OF THE INVENTION

The invention provides systems and methods for iterative definition of the flat file structure from a document instance. The invention simplifies the process of defining the conversion rules for the flat file formats. These rules are used by components that perform conversion from flat file format to XML and back. The invention allows definition of those rules by working with the flat file document instance and iteratively creating an XML schema from that instance.

A format definition method according to the invention simplifies a very common task that developers need to perform in EAI and B2B solutions. There are plenty of applications in EAI and B2B spaces that still have not adopted and have no plans to adopt XML formats for data interchange. In order to utilize the XML technologies while working with data from those applications, developers may need to be able to translate the data from custom flat file formats to XML format.

The invention enables users to define an XML schema for parsing flat files by using familiar user interface constructs that are already utilized in other known products, such as Microsoft Excel Text data import wizard and Microsoft SQL DTS data import wizard, for example. The invention allows developers to interactively create a parsing schema quickly and with minimal knowledge necessary. It also reduces the parsing schema debugging time considerably as it eliminates most of the user errors by guiding the developer through the schema creation process.

### BRIEF DESCRIPTION OF THE DRAWINGS

FIG. 1 is a block diagram showing an example computing environment in which aspects of the invention may be implemented.

FIG. 2 depicts an example flat file.

FIG. 3 is a flowchart of an example iterative schema definition process.

FIGS. 4A-4G depict example user interfaces that may be used in connection with an iterative schema definition process.

FIG. 5 depicts an example XSD corresponding to the flat file depicted in FIG. 2.

### DETAILED DESCRIPTION OF ILLUSTRATIVE EMBODIMENTS

Example Computing Environment

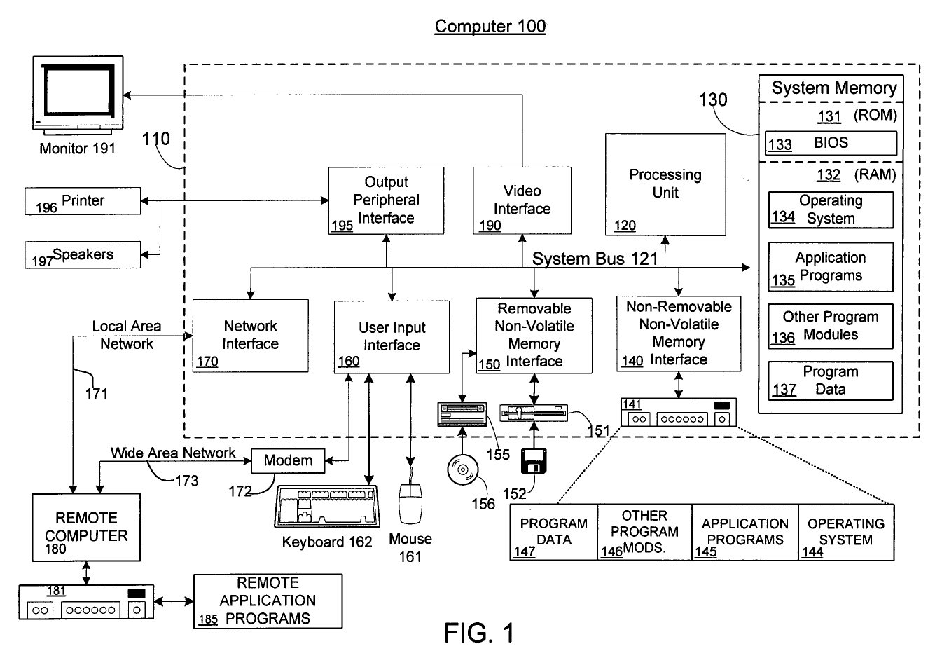

FIG. 1 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

With reference to FIG. 1, an example system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 10 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120a-f through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a standalone computing device, having programming language functionality, interpretation and execution capabilities.

Iterative Definition of Flat File Data Structure by Using Document Instance

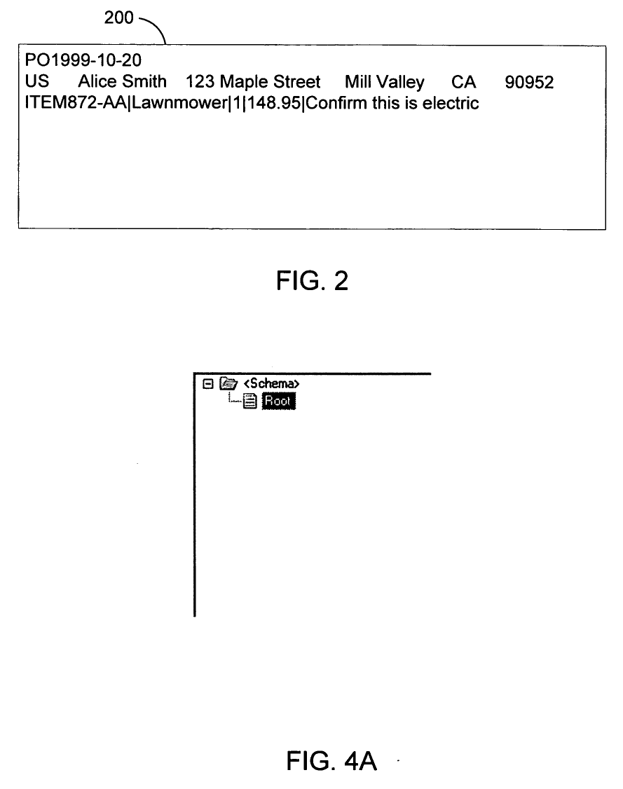

FIG. 2 depicts a typical document instance of a typical flat file 200. A legacy application, for example, may produce data in the format shown. For example, as shown, the flat file may correspond to a purchase order. It should be understood, of course, that the flat file may be any flat file, and that the example of a purchase order is provided for explanatory purposes only.

A typical flat file 200 may include any number of data fields. The example flat file 200 depicted in FIG. 2 includes data fields corresponding to file type (PO), date-time (1999-10-20), country (US), name (Alice Smith), street address (123 Maple Street), city (Mill Valley), state (CA), ZIP code (90952), item number (ITEM872-AA), item type (Lawnmower), quantity (1), price (148.95), and comments (Confirm this is electric). As shown, one or more data fields may be on a first line (e.g., file type and date-time), one or more data fields may be on a second line (e.g., country, name, street address, city, state, and ZIP code), and one or more data fields may be on a third line (e.g., item number, item type, quantity, price, and comments).

To enable processing of flat files having such a format, a developer may wish to define a flat file schema. An example of a flat file schema definition may be an XML schema definition (“XSD”), with additional flat file annotations.

The invention provides an iterative definition process that may include interactive creation of a flat file schema with flat-file-specific annotations from the flat file document. Such a process may be implemented by using a “wizard”-like tool or a dialog control. The tool may provide a user interface for each step of the iterative schema definition process.

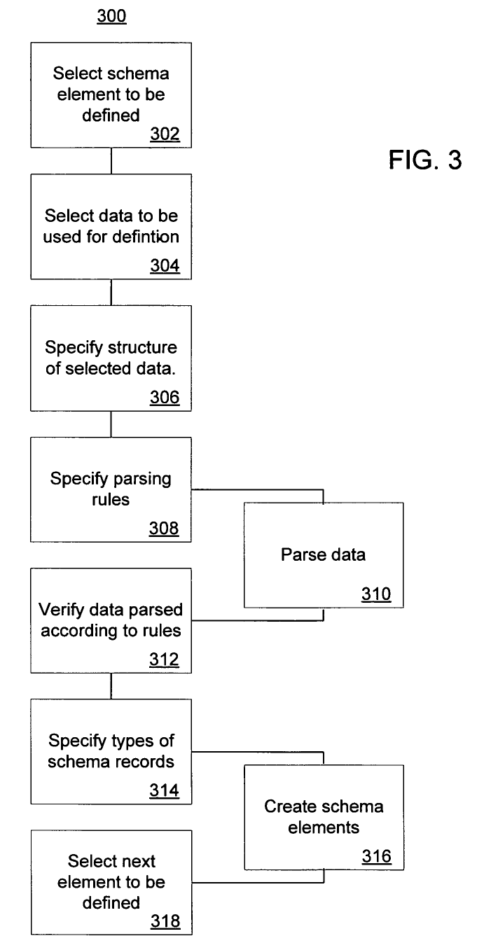

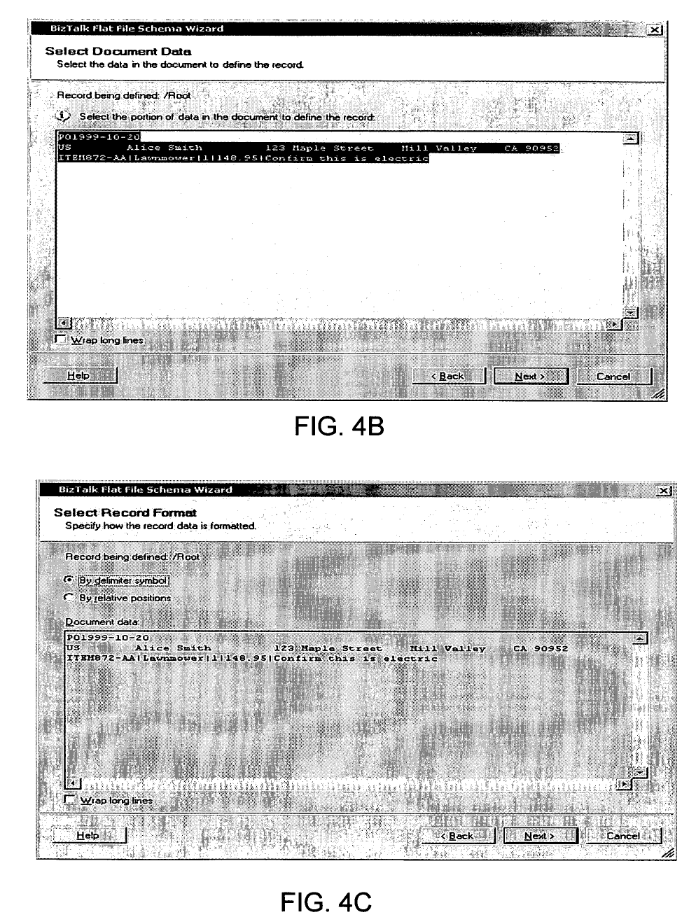

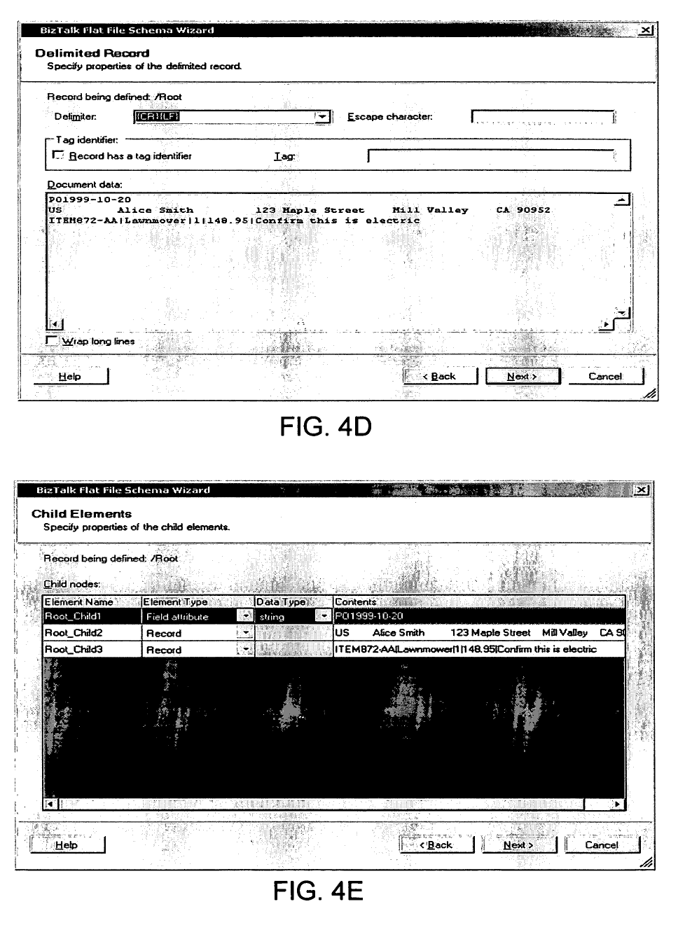

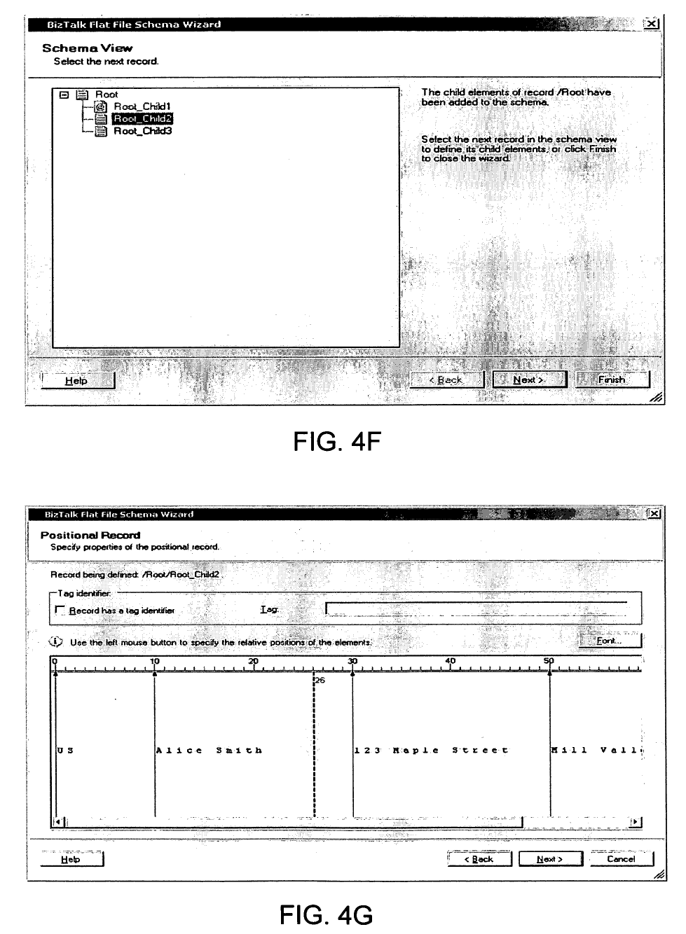

FIG. 3 is a flowchart 300 of an example of such an iterative process. First, at step 302, the user may select a schema element to be defined. FIG. 4A depicts an example user interface for selecting a schema element to be defined (e.g., “Root”).

At step 304, the user may select all or part of the data in the document instance to be used to define the record. FIG. 4B depicts an example user interface for selecting data in a document instance to define a record. The user may select the data to be used for schema definition by highlighting the data selection and clicking the “Next” button.

At step 306, the user may specify the structure of the selected part of the document, that is, how the record data is formatted. FIG. 4C depicts an example user interface for specifying the structure of a selected part of a document. The structure may be delimited or positional. That is, the record may be defined by delimiter symbol or by relative positions.

As described above in connection with FIG. 2, and as depicted in FIG. 4C, the selected data from the document instance/Root includes respective data fields on each of three lines. Thus, each line may be considered a record, where successive records are delimited by a <CR><LF>. To separate the record/Root into a plurality of records by delimiter symbol, the user may select “By delimiter symbol” and click on the “Next” button.

At step 308, the user may specify parsing rules for processing the selected data. FIG. 4D depicts an example user interface for specifying parsing rules for processing selected data by delimiter symbol. As shown, the user may specify properties of the delimited record. For example, the user may specify a delimiter symbol that separates the records in the selected data (e.g., <CR><LF>).

At step 310, the tool parses the selected data in accordance with the specified parsing rules. For example, the tool may separate the record Root into three child records, one for each line.

At step 312, the user may verify that the data has been parsed as expected (e.g., in accordance with the parsing rules). FIG. 4E depicts an example user interface for verifying that a data record has been parsed as expected. As shown, the parent element, Root, has been parsed into three child elements, Root_Child1, Root_Child2, and Root_Child3, each of which corresponds to a respective one of the lines in Root. It should be understood that the names of the child elements may be created using some default naming convention and that the user may overwrite them with any desired names.

At step 314, the types of schema elements corresponding to each child element may be specified. FIG. 4E depicts an example user interface for specifying types of schema elements. Example element types include Record, Field Attribute, Field Element, and Repeating Record. For example, as shown, the element Root_Child1 includes the data field from the first line of the parent record, Root, (i.e., date-time). The element type for this element may be specified as a “Field Attribute.” The element Root_Child2 includes the data fields from the second line of the parent record, Root, (i.e., country, name, street address, city, state, and ZIP code). The element type for this element may be specified as a “record.” The element Root_Child3 includes the data fields from the third line of the parent record, Root, (i.e., item number, item type, quantity, price, and comments). The element type for this element may also be specified as a “record.” Generally, if the user does not want to parse the element further, then the user can set the element type as an element or attribute. If further parsing is desired, then the element may be specified as a record or repeating record.

A data type corresponding to each child element may also be specified. Example data types include any XSD types, such as string, integer, unsigned integer, datetime, etc. As shown, the element Root-Child1 may be specified as having a date type of “string.”

After the user verifies that the data has been parsed as expected and verifies the types of schema elements corresponding to each child element, the user may cause the tool to create the schema elements in the schema by clicking the “Next” button. At step 316, the tool may create the schema elements.

At step 318, the user may select the next schema element to be defined on the next iteration. FIG. 4F depicts an example user interface for selecting a next schema element to be defined on a next iteration. As shown, the parent element, Root, may be presented, along with a hierarchy tree that shows the relationship between the several elements. For example, the tree may show the three child elements, Root_Child1, Root_Child2, and Root_Child3 as siblings descending from a common parent element, Root. The user may select the next schema element to be defined by highlighting the child element name, “Root_Child2,” for example, and then clicking the “Next” button.

Steps 304-316 may then be repeated for the next selected element, e.g., Root-Child2. The data fields in Root_Child2 may be defined by relative position. As shown, each data field may have a constant field length and the fields may be immediately adjacent to one another (i.e., with no characters between the end of one field and the start of the next field). Alternatively, adjacent fields may be separated from one another by a known, fixed number of characters. For the record Root-Child2, the user may specify, at step 306, that the record is being defined “By relative positions” and clicking on the “Next” button (see FIG. 4C).

FIG. 4G depicts an example user interface for specifying, at step 308, parsing rules for processing selected data by relative positions. If the data structure is positional, then the user may specify respective relative positions of the elements. As shown, the user may provide the relative positions of the several elements contained within the record being defined by establishing a respective delineation at the beginning and end of each element. In an example embodiment, as depicted in FIG. 4D, the user may “drag-and-drop” a (dashed) line onto the beginning or end of an element. The user may then release the line when the user is satisfied with its position along the element (and the line may become solid).

When the user is satisfied that all the elements have been properly delineated, the user may then click the “Next” button to cause the tool to parse the selected data, at step 310, in accordance with the specified parsing rules. For example, the tool may separate the record Root_Child3 into one or more child elements, (e.g., one each for country, name, street address, city, state, and ZIP code).

As shown throughout FIGS. 4A-4G, the user interfaces can provide any number of functional buttons to enable the user to perform certain functions throughout the process. For example, a “Back” button may be provided to enable the user to back up through the process, a “Cancel” button may be provided to enable the user to cancel the process mid-stream, and a “Finish” button may be provided to enable the user to terminate the process when it is completed.

Note that, where data fields are separated by delimiter symbols, the data fields may have variable length. The data fields in the third line of Root, for example, have variable lengths and are separated by delimiter symbol “|”. A delimiter symbol associated with a field may be placed before or after the associated field. There may or may not be delimiter symbols at the beginning and/or end of a line. A delimiter symbol may include one or more characters. Different delimiter symbols may be used in the same file.

If the next selected element is a child of an element that was selected during a previous iteration, then the corresponding part of the data may be selected automatically at step 304. Thus, as the user goes through successive iterations, the tool can self-discover selections of the data that correspond to the selected schema element.

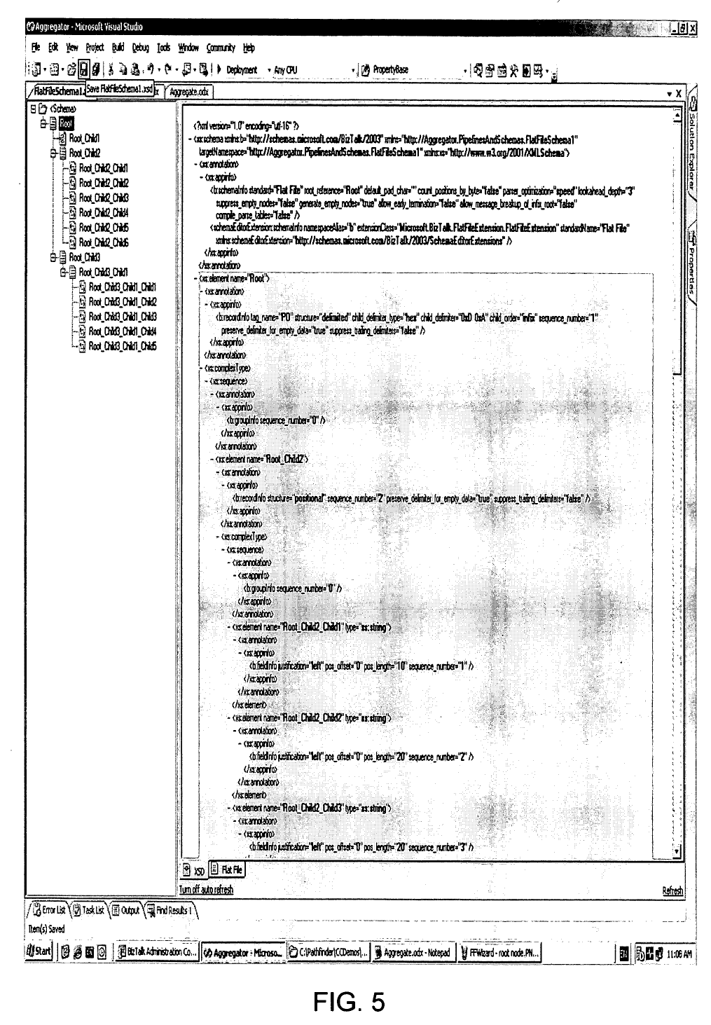

As described above, the invention provides a method and tool for generating metadata describing the format of a flat file based on an instance of the flat file. Such a method enables a user to get from an instance of a flat file to the metadata (e.g., XSD). FIG. 5 depicts an example XSD file corresponding to the flat file depicted in FIG. 2.

Thus, according to the invention, an XML schema, for example, may be generated from a flat file instance. The generated schema can be compiled and used in flat file pipeline components. The tool provides a visual, open flat file instance, such that the user need not manually enter the flat file instance. The user of the tool may be developer whose system consumes flat files, where the developer wants to know the structure of the flat file (by looking at the metadata, for example). Accordingly, a developer may be enabled to normalize data that can be massaged and put out in an alternative format.

What is claimed:

1. A method for generating metadata describing the format of a flat file based on an instance of the flat file, the method comprising:
selecting an instance of a flat file;
specifying a parsing rule for parsing selected data in the flat file into at least one record;
specifying a schema element type corresponding to the at least one record; and
causing a schema element associated with the at least one record to be created.

2. The method of claim 1, wherein the schema element is an XML schema element.

3. The method of claim 2, wherein the parsing rule defines a rule for translating the selected data into an equivalent XML representation.

4. The method of claim 3, wherein the parsing rule defines a rule for translating the XML representation into a flat file representation.

5. The method of claim 1, wherein the metadata is an XML schema definition (XSD).

6. The method of claim 5, wherein the parsing rule is for parsing the selected data into a plurality of records, the method further comprising:
causing a respective schema element associated with each of the plurality of records to be created; and
creating an XSD file from the respective schema elements.

7. A method for generating metadata describing a flat file format based on an instance of the flat file, the method comprising:
selecting data in an instance of a flat file;
specifying a rule for translating the selected data into an equivalent XML representation and the XML representation into a flat file representation;
translating the selected data into the equivalent XML representation according to the rule, thereby generating metadata describing a format of the selected data.

8. The method of claim 7, wherein the specified rule includes a parsing rule for parsing the selected data into at least one child element, and the parsing rule is based on a structure of the selected data.

9. The method of claim 8, wherein the structure is associated with a formatting of the data.

10. The method of claim 9, wherein the structure is delimited.

11. The method of claim 9, wherein the structure is positional.

12. The method of claim 8, further comprising specifying the structure of the selected data.

13. The method of claim 8, further comprising verifying that the selected data has been parsed in accordance with the parsing rule.

14. The method of claim 8, further comprising specifying a schema element type corresponding to the at least one child element.

15. The method of claim 14, further comprising specifying a data type corresponding to the at least one child element.

16. The method of claim 8, further comprising selecting the at least one child element to be parsed into at least one grandchild element, and causing a schema element associated with the at least one grandchild element to be created.

17. The method of claim 8, wherein the parsing rule is for parsing the selected data into a plurality of records, the method further comprising:
causing a respective schema element associated with each of the plurality of records to be created; and
creating an XSD file from the respective schema elements.

18. A tool for generating metadata describing the format of a flat file based on an instance of the flat file, the tool comprising:
a data selection interface for enabling a user to select selected data in a schema element;
a rule specification interface for enabling a user to specify a parsing rule for parsing the selected data into at least one child element;
a type specification interface for enabling a user to specify a schema element type corresponding to the at least one child element; and
means for generating an XSD schema element associated with the at least one child element and based on the specified schema element type.

19. The tool of claim 18, further comprising means for parsing the selected data in accordance with the specified parsing rule.

20. The tool of claim 18, further comprising:
a child element selection interface for enabling a user to select the at least one child element for parsing into at least one grandchild element; and
means for generating an XSD schema element associated with the at least one grandchild element.
